(19) United States
(12) Patent Application Publication
(10) Pub. No.: US 2007/0258474 A1
(43) Pub. Date: Nov. 8, 2007

(54) METHOD AND SYSTEM OF PROVIDING RSS CONTENT BY DMS TO DEVICES IN DLNA NETWORK

(76) Inventors: Chul Seung Kim, Seoul (KR); Ho Chul Shin, Suwon-si (KR); Young Kyu Bae, Suwon-si (KR); Yun Je Oh, Yongin-si (KR); Joon Oo Kim, Suwon-si (KR)

Correspondence Address: CHA & REITER, LLC, 210 ROUTE 4 EAST STE 103, PARAMUS, NJ, 07652, US

(21) Appl. No.: 11/671,602

(22) Filed: Feb. 6, 2007

(30) Foreign Application Priority Data
May 8, 2006 (KR) 2006-0041002

(51) Int. Cl. H04L 12/56

(52) U.S. Cl. 370/401

(57) ABSTRACT

A method of providing RSS content by a DMS to devices in a DLNA network, and more particularly, a method, system, computer program product and device is disclosed. The method comprises the steps of converting RSS content data to an image, storing the image, and sharing the image with devices (e.g., DMP, DMR) in the DLNA network when requested. The method of providing RSS content by a DMS to devices in a DLNA network includes receiving RSS content data, parsing the RSS content data, and composing the parsed data in a page, converting the composed page to an image and storing the converted image, registering an RSS image list, periodically monitoring the registered result, and informing the devices in the DLNA network of the result and searching for, and providing, a corresponding RSS content image when a request for using the stored RSS content image is received from the devices in the DLNA network.

### CLAIM OF PRIORITY

This application claims the benefit of the earlier filing date, pursuant to 35 USC 119, to that patent application entitled “Method And System Of Providing RSS Content By DMS To Devices In DLNA Network” filed in the Korean Intellectual Property Office on May 8, 2006 and assigned Serial No. 2006-0041002, the contents of which are incorporated herein by reference.

### BACKGROUND OF THE INVENTION

1. Field of the Invention

The present invention relates to RSS content in a DLNA network, and more particularly, to a method and system of converting Rich Site Summary (RSS) content data to an image, storing the image, and sharing the image in several devices in the DLNA network.

2. Description of the Related Art

Recently, people connected to an IP network receive or exchange AV (audio/visual)content, such as music or an image from an individual, a broadcasting station, or a specific content provider, with or without charge. For example, they can watch or listen to a television program or music through the Internet.

In order to exchange content between electric appliances, the electric appliances recognize their presence in a network, the content of the electric appliances is searched, and the electric appliances exchange desired content through the network.

Several middleware, including UPnP, HaVi, Jini, VESA, and DLNA, are used so that electronic appliances recognize the presence of other electronic appliances in a network, search their content, and exchange desired content. A Digital Living Network Alliance (DLNA, as one of the middleware, is preferable used in the present invention.

The DLNA is preferably used to share content provided from electronic appliances, such as a TV, a VCR, a digital camera, and an audio instrument. In order to share the content among these devices, interoperability between the appliances is first required. A home network for sharing content includes, typically, a personal computer (PC) Internet network (a PC, a printer, etc.), a mobile network (a PDA, a mobile phone, a notebook, etc.), an electronic appliance network (a TV, an audio instrument, a DVD player, etc.). Each network and appliances connected thereto requires standardization for interoperability frame work.

Particularly, the DLNA enables a consumer to acquire digital media content (picture, music, video, etc.) from a device, such as a mobile device or a PC, and to transmit and manage the received content. Furthermore, the DLNA allows consumers to freely enjoy the content regardless of location and basic characteristics of the devices in a home.

FIG. 1 is a view illustrating a general DLNA network system.

The DLNA network system of FIG. 1 is based on a universal plug and play (UPnP) protocol and includes a digital media server (DMS) 103, a digital media player (DMP) 105, a digital media controller (DMC) 106, and a digital media renderer (DMR) 107, and is connected though wired and wireless networks 101.

The DLNA system may be connected to the network 101 via an access point (AP) 109.

The DLNA network system comprises a home network system using a wired network (IEEE 802.3) and/or a wireless network (IEEE 802.11). The DMS 103, DMP 105, and DMR 107 in the home network are connected to each other through the wired network and/or the wireless network. Digital appliances in the home network can transmit data, such as images and voice by IEEE 1394 port in a wired network.

In DLNA standardization, devices for connection between home network appliances are classified as a DMS, a DMP, a DMC or a DMR. A connection condition between the DMS, the DMP, the DMC or the DMR is also a standard reference.

The DMS may access content of a media server device (MSD) using an UPnP AV protocol and store digital media content, and may include a DMR function. A main object of the DMS is to search digital media content within the DMS and display the content or distribute content. The relationship of the DMS and the DMR is as follows. The DMS, as a device for receiving digital broadcasting, receives and stores a broadcasting signal, then provides the received content to the DMR when a request is received from the DMR. The DMR then reproduces the content. The DMP is a DMR including a control point (CP) and performs the function of selecting and controlling media content of a media renderer device and executing the selected media content. Various media content provided to the DMP and the DMR through the DMS can be received from several devices by various methods.

Recently, media content, e.g., news or information, may be quickly and conveniently transmitted through a blog (a web-blog available on the world wide web) of the Internet. As a blog is more widely used, a Web user may directly search blogs so as to obtain a significant amount of information. However, sometimes it is difficult and inconvenient to directly search several blogs. This is because many blog sites transmit information using RSS format and files of the RSS format are generated with various standards. The RSS format, preferably has a standard for combination of XML websites and creation and exchange of data. For example, a site requiring frequent updating, such as a news site has an XML based standard. The RSS is an acronym for “Rich Site Summary” or “Really Simple Syndication,” and there are RSSs of various standards. An RSS file may be generated using various standards and contains information of a specific site for a Web user. For example, if new information is registered in a specific blog site, an RSS generator automatically updates a new information list and generates an updated RSS file. Therefore, even if files of RSS format are formed with various standards, brief explanations, such as a title and a URL of information, are included in the RSS files. A Web user can check whether there is newly included information in the blog site by acquiring only an RSS file of the blog site. Further, because the RSS file includes URL data of newly registered or included information, a user can directly connect to the information.

However, when devices (DMP and DMR) in the DLNA network use an RSS service, an additional stack related to the RSS is required because over head may be generated in a device having low performance. Further, because various RSS standards exist and the formats of the RSS pages is changed when the devices in the DLNA network receive RSS service, each device must separately have an RSS reader function. Accordingly, when devices cannot share the RSS content, each of the DMP and the DMR should directly connect to a Web site to download the RSS content, and it is difficult to utilize characteristics of the DLNA network.

### SUMMARY OF THE INVENTION

The present invention has been made in an effort to solve the above problems and provides additional advantages, by providing a method and system that can convert RSS content data received by a DMS to an image, store the image, and share the image with the devices in the DLNA network.

One aspect of the present invention is to provide a method and system whereby devices that cannot connect to the Internet can share and use RSS content data in a DLNA network.

Another aspect of the present invention is to provide a method and system whereby devices having no RSS reader function can check and use RSS content data.

Another aspect of the present invention is to provide a method and system of automatically recognizing a generated RSS image.

In accordance with an aspect of the present invention, the above and other objects are accomplished by a method of providing RSS content by a DMS to devices in a DLNA network including composing a page by downloading RSS content data and converting the composed page to an image, storing the converted 5 image and sharing the stored image with devices in the DLNA network using content directory service (CDS).

In accordance with another aspect of the present invention, a method of providing RSS content by a DMS to devices in a DLNA network includes obtaining RSS content data, composing the obtained RSS content data in a page by 10 parsing the RSS content data, converting the composed page to a RSS content image, and storing the converted RSS content image and enabling devices in a DLNA network to share the stored RSS content image.

Preferably, the method further includes registering an RSS content image list in the DMS, periodically monitoring the registered result and informing 1 5 devices in the DLNA network of the result, checking whether a request for using the stored RSS content image is received from the devices in the DLNA network and searching for and providing the corresponding RSS content image.

In accordance with another aspect of the present invention, a system for providing RSS content by a DMS to devices in a DLNA network includes a 20 communication interface for receiving and transmitting RSS content data, an RSS engine for parsing RSS content data and composing the data in a page, an image generator for converting the composed page to a RSS content image, a memory for storing the converted RSS content image, and a controller for (1) controlling the communication interface, RSS engine, image generator, and memory, (2) controlling the conversion of the RSS content data to a RSS content image, (3) controlling the registration of an RSS content image list in the CDS, (4) controlling access of the devices in the DLNA network to the RSS content image list, and (5) controlling the search of requested RSS content image in the memory, and transmitting the image to the devices in the DLNA network.

Program data and random data of the CDS, a connection manager service (CMS), and an AV transport service (ATS) may be stored in the memory by the controller and may be stored in a storage media such as a hard disc drive rather than the memory.

### BRIEF DESCRIPTION OF THE DRAWINGS

The above features and advantages of the present invention will be more apparent from the following detailed description in conjunction with the accompanying drawings, in which;

FIG. 1 is a view illustrating a general DLNA network system;

FIG. 2 is a block diagram of a DMS in a DLNA network according to an exemplary embodiment of the present invention; and

FIG. 3 is a flowchart illustrating a method of providing RSS content by a DMS to devices in a DLNA network according to an exemplary embodiment of the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

While the present invention may be embodied in many different forms, specific embodiments of the present invention are shown in drawings and are described herein in detail, with the understanding that the present disclosure is to be considered as an exemplification of the principles of the invention and is not intended to limit the invention to the specific embodiments illustrated.

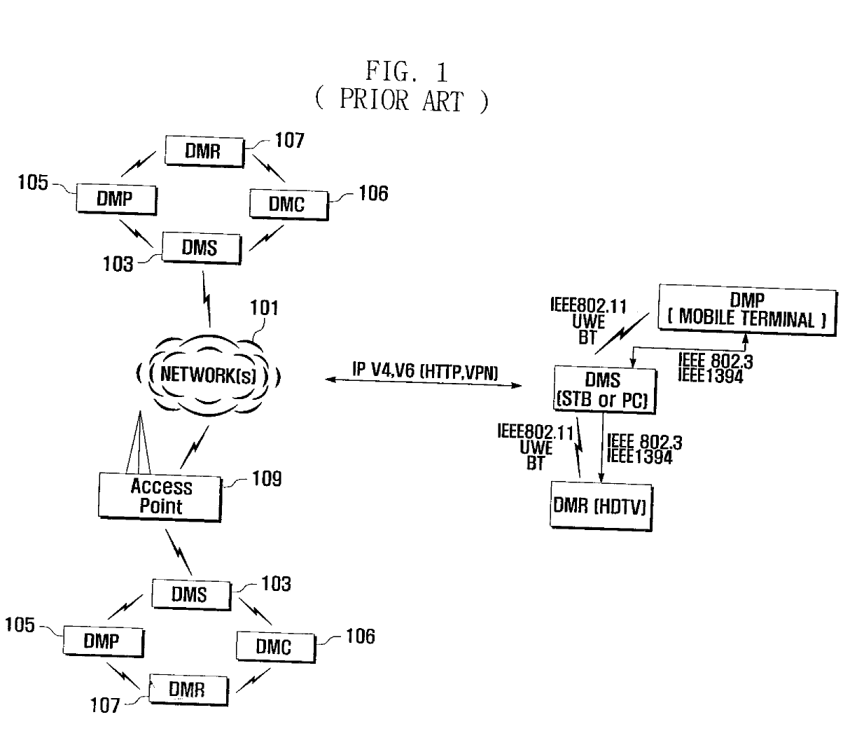

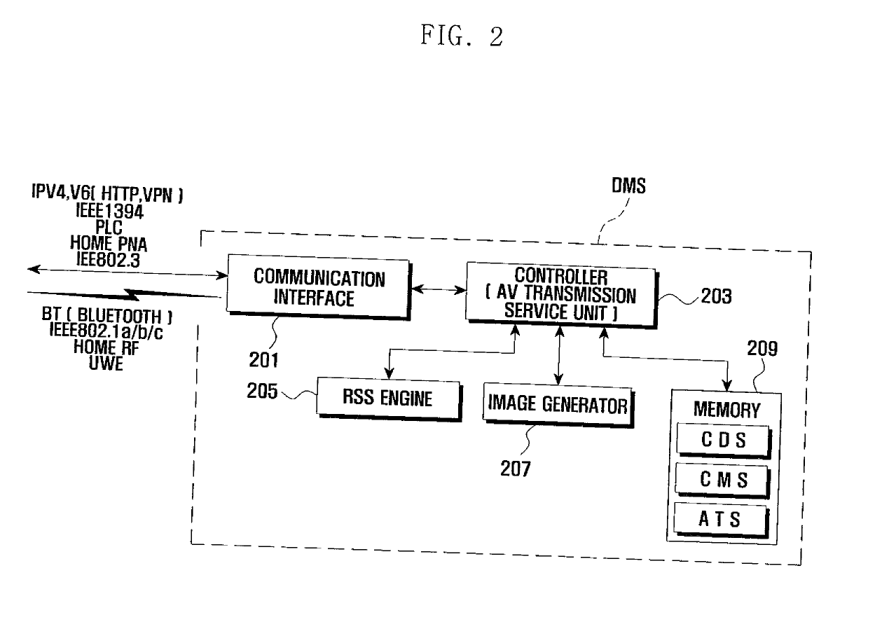

FIG. 2 is a block diagram of a DMS in a DLNA network according to an exemplary embodiment of the present invention, where the DMS containing the RSS content may be one of the DMSs shown in the DLNA network of FIG. 1. The DMS includes a communication interface 201, a controller 203, an RSS engine 205, an image generator 207 and a memory 209.

The communication interface 201 is connected to the Internet with an IPv4 or IPv6 protocol. An internal network is connected by a wired method, for example, IEEE1394, PLC, Home PNA, and IEEE802.3 or a wireless method, for example, Bluetooth, IEEE802.1a/b/c/n, Home RF, or UWE, to receive RSS content data. When the RSS content data is converted and stored in a RSS content image, if a request for the image is received from one of the devices (DMP and DMR) in a DLNA network, the communication interface 201 transmits the image to the requesting device(s).

The RSS engine 205 composes a page by parsing RSS content data.

The image generator 207 converts the parsing result to a RSS content image. That is, the RSS content data is received through the Internet by the communication interface 201, parsed in the RSS engine 205 under the control of the controller 203, and is converted to a RSS content image by the image generator 207.

The converted RSS content image is stored in the memory 209, and program data and random data of CDS, CMS, and ATS are stored in the memory 209 under the control of the controller 203.

The controller 203 controls the communication interface 201 of the ATS to transmit and receive RSS content in a DMS of the DLNA network, the RSS engine 205 to compose a page, by parsing RSS content data received from other devices, and the image generator 207 to convert the composed page from the RSS engine 205 to an RSS content image. The controller 203 further controls the storage of the RSS content image in the memory 209 so that the devices in the DLNA network may share the RSS content image, and periodically monitors whether there is a new RSS content image stored in the memory 209. The controller 203 stores the converted RSS content image in the memory 209 and simultaneously registers an RSS content image list in the CDS. The controller 203 controls the devices in the DLNA network so that they can easily access the RSS content image through the CMS of the memory 209 by informing the devices in the DLNA network of the content list registered in the CDS. The controller 203 searches for, and provides, the corresponding RSS content image stored in the memory 209 when a request for the stored RSS content image is received from the devices in the DLNA network.

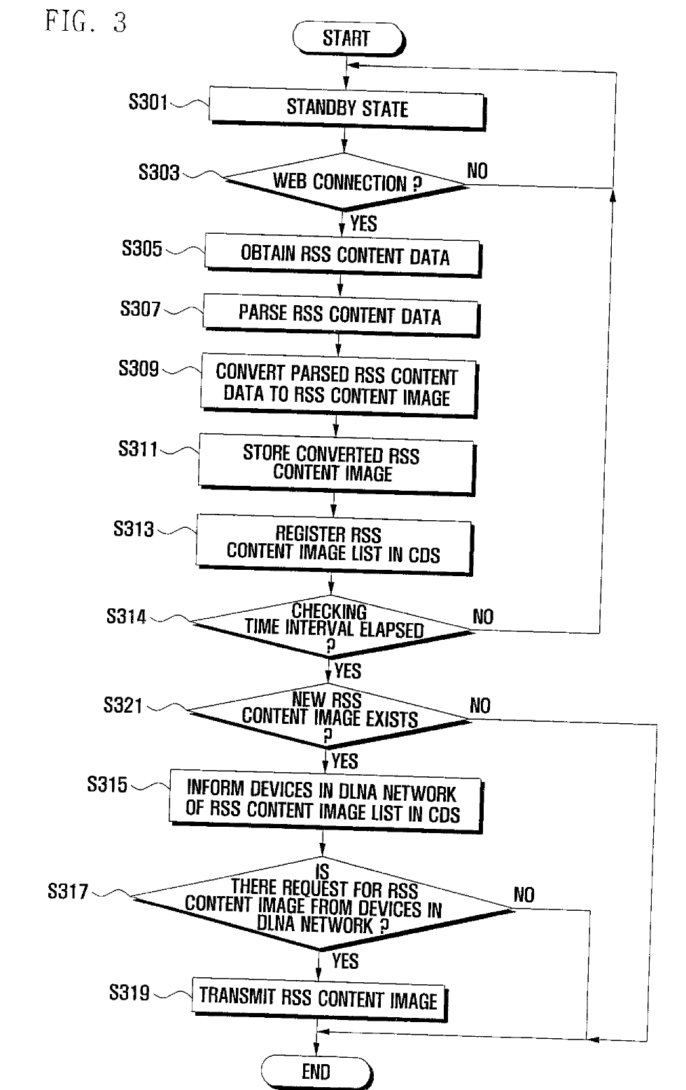

FIG. 3 is a flowchart illustrating a method of providing RSS content by a DMS to devices in a DLNA network according to an exemplary embodiment of the present invention.

The method is described here in detail, with reference to FIGS. 1 to 3.

The DMS of FIG. 2 begins with a stand-by status mode (5301). The controller 203 of the DMS checks whether the DMS is connected to a Web site of the Internet through IPv4 or IPv6 protocol(S303). If the DMS is connected to a Web site, RSS content data is downloaded under the control of the controller 203 through the communication interface 201 (S305). The controller 203 controls the RSS engine 205 to parse the downloaded RSS content data and then composes the data in a predetermined page format (S307). The controller 203 controls the image generator 207 to convert the composed page to a RSS content image (S309). The controller 203 controls the memory 209 to store the converted RSS content image in the memory 209 (S311) and to simultaneously register an RSS content image list in the CDS (S313). The converted RSS content image may be stored by moving the image to a separate high-capacity storage (not shown) such as an HDD (hard disk drive).

The controller 203 periodically monitors the memory 209 or the storage, and automatically recognizes and processes the image whenever a new RSS content image is generated. Thereto, the controller 203 determines whether a predetermined checking time interval has elapsed (S314). If a checking time interval has elapsed, the controller 203 then checks whether a newly generated RSS content image exists in the memory 209 or the storage (S321). If, at step S321, a newly generated RSS content image is determined to exist, the controller 203 informs devices, e.g., the DMP 105 and the DMR 107, in the DLNA network of a list of RSS content image including the newly generated image registered in the CDS of the memory 209, through a wired connection (IEEE1394, PLC, Home PNA, and IEEE802.3) and/or wireless connection (Bluetooth, IEEE802.1a/b/c/n, Home RF, and UWE) (S315). The controller 203 of the DMS periodically monitors whether there is a new generated RSS content image in the memory 209. When it is 10 determined a newly generated RSS content image exists in the memory 209, the controller 203 of the DMS informs the devices, i.e., the DMP 105 and the DMR 107 in the DLNA network, of an updated RSS content image list. The DMP 105 and the DMR 107 can access the RSS content image by the CMS in the memory 209. The controller 203 determines whether a user's request for the RSS content image has been received through a wired and/or wireless connection from the DMP 105 and the DMR 107 (S317). If a user's request for the RSS content image has been received, the controller 203 searches for the RSS content image in the memory 209 and provides the image to the corresponding DMP 105 or DMR 107 by the ATS (S319).

As described above, according to an exemplary embodiment of the present invention, since RSS content data are shared in the DLNA network, the RSS content data can be used in devices that cannot connect to the Internet, and the RSS content data can be checked even in devices having no RSS reader function.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be clearly understood that many variations and modifications of the basic inventive concepts herein taught that may appear to those skilled in the present art will still fall within the spirit and scope of the present invention, as defined in the appended claims.

What is claimed is:

1. A method of providing Rich Site Summary (RSS) content by a digital media server (DMS) to devices in a Digital Living Network Alliance (DLNA) network comprising the steps of:
composing a page by downloading RSS content data and converting the composed page to an image; and
storing the converted image and sharing the stored image with the devices in the DLNA network using content directory service(CDS).

2. A method of providing RSS content by a DMS to devices in a DLNA network comprising the steps of:
obtaining RSS content data;
composing the obtained RSS content data in a page;
converting the composed page to an RSS content image and storing the converted image; and
sharing the stored RSS content image with the devices in the DLNA network.

3. The method of claim 2, wherein composing the obtained RSS content data in a page is performed by parsing.

4. The method of claim 2, further comprising the steps of:
registering an RSS content image list in the DMS;
periodically monitoring the registered result and informing the devices in an DLNA network of the result;
responsive to a request for a selected stored RSS content image; and
searching for and providing the corresponding RSS content image.

5. The method of claim 4, wherein registering an RSS content image list is performed using the CDS in the DMS.

6. The method of claim 4, wherein the RSS content image is automatically searched for and retrieved in the devices in the DLNA network.

7. A method of providing RSS content by a DMS to devices in a DLNA network comprising the steps of:
receiving RSS content and parsing the RSS content;
converting the parsed result to an image and storing the converted image;
registering an RSS content image list;
periodically monitoring the registered result, informing devices in the DLNA network of the result; and
searching for and providing requested RSS content image when a request for stored RSS content image is received from the devices in the DLNA network.

8. A system for providing RSS content by a DMS to devices in a DLNA network comprising:
a parsing unit for receiving RSS content data and parsing the RSS content data;
a conversion and storage unit for converting the parsed result of the RSS content data to a RSS content image and storing the converted image;
a controller for:
registering an RSS content image list;
periodically monitoring the registered result, and
informing devices in the DLNA network of the result; and
an image provider for searching for and providing corresponding RSS content image when a request stored RSS content image is received from the devices in the DLNA network.

9. A system for providing RSS content by a DMS to devices in a DLNA network comprising:
a communication interface for receiving and transmitting RSS content data;
an RSS engine for parsing received RSS content data and composing the data in a page;
an image generator for converting the composed page to a RSS content image;
a memory for storing the converted RSS content image; and
a controller for:
controlling the communication interface, RSS engine, image generator and memory,
controlling conversion of the RSS content data to a RSS content image,
controlling registration of an RSS content image list in CDS,
controlling access of the devices in the DLNA network to the RSS content image using the content list of CDS, and
controlling, responsive to a request for RSS content, searching for the requested RSS content image in the memory, and transmitting the image to the devices in the DLNA network.

10. A computer program product, including computer instruction, which when loaded into a computer system causes the computer system to execute the steps of:
composing a page by downloading RSS content data and converting the composed page to an image; and
storing the converted image and sharing the stored image with a devices in a DLNA network using content directory service(CDS).

11. A computer-program product including computer instruction, which when loaded into a computer system causes the computer system to execute the steps of:
obtaining RSS content data;
composing the obtained RSS content data in a page;
converting the composed page to an RSS content image and storing the converted image; and
sharing the stored RSS content image with a devices in a DLNA network.

12. The computer program product of claim 11, wherein composing the obtained RSS content data in a page is performed by parsing.

13. The computer program product of claim 11, wherein the computer instruction causes the computer system to further execute the steps of:
registering an RSS content image list in the DMS;
periodically monitoring the registered result and informing the devices in an DLNA network of the result;
responsive to a request for a selected stored RSS content image; and
searching for and providing the corresponding RSS content image.

14. The computer program product of claim 13, wherein registering an RSS content image list is performed using the CDS in the DMS.

15. The computer program product of claim 13, wherein the RSS content image is automatically searched for and retrieved in the devices in the DLNA network.

16. A device for providing RSS content to devices in a DLNA network, the device comprising:
a processor in communication with a memory, the processor executing the steps of:
receiving RSS content and parsing the RSS content;
converting the parsed result to an image and storing the converted image;
registering an RSS content image list,
periodically monitoring the registered result, informing devices in the DLNA network of the result; and
searching for and providing requested RSS content image when a request for stored RSS content image is received from at least one device in the DLNA network.
